(19) United States
(12) Patent Application Publication
(10) Pub. No.: US 2008/0041537 A1
(43) Pub. Date: Feb. 21, 2008

(54) Storm curtain assembly having edge tracking system and roller and lock bar attachment features

(76) Inventors: Willis J. Mullet, Gulf Breeze, FL (US); Darrin W. Brunk, Pensacola, FL (US); Richard S. Hand, Pace, FL (US); Derek S. Paquette, Daphne, AL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/788,324

(22) Filed: Apr. 19, 2007

Related U.S. Application Data
(60) Provisional application No. 60/816,792, filed on Jun. 27, 2006.

(51) Int. Cl. E06B 9/58

(52) U.S. Cl. 160/271

(57) ABSTRACT

A storm curtain assembly (10) includes a header (11) and side rails (13) extending downwardly from each end of the header (11). A roll (15) is positioned in the header (11) and carries a fabric curtain (14) which has one end attached to the roll (15). A bar (16) is attached to the other end of the fabric curtain (14). A track (20) is formed on each side rail (13), and the edges of the fabric curtain (14) are normally received in the tracks (20). One of the walls (18) which forms the track (20) terminates at an upper edge (21) which is spaced from the header (11) so that if an edge of the fabric curtain (14) is displaced from the track (20), the displaced edge will be allowed to be received in the track (20) as the fabric curtain (14) is being received on the roll (15).

### CROSS REFERENCE TO RELATED APPLICATION

This application claims the benefit of U.S. Provisional Application Ser. No. 60/816,792 filed Jun. 27, 2006.

### TECHNICAL FIELD

This invention relates to a curtain assembly which protects an opening in a building from damage due to high winds and wind-borne debris oftentimes present during storm conditions. More specifically, this invention relates to the manner in which the curtain is attached to its supply roll and to its locking bar, and to a curtain which is provided with a tracking system to maintain its edges in the side rails of the system.

### BACKGROUND ART

In geographic areas which are prone to having high wind events, such as hurricanes and the like, the need exists for the protection of openings, such as windows and doors, in buildings. Otherwise, if the high winds or wind-borne debris breaches the integrity of the structure by destroying a window or door, severe damage to the structure can be expected.

In its most simple form, one type of known protection device which can be utilized is a simple sheet of plywood which can be attached to the structure so as to cover the openings thereof. However, this “boarding up” procedure is not only time consuming, when time is usually of the essence, but also can disfigure the exterior of the structure upon frequent installation and removal. Moreover, the plywood deteriorates with time, and storing and maintaining an inventory of plywood sheets can be problematic.

As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also they do not provide the necessary seal irrespective of whether they are mounted on the windward or leeward side of the building.

More recently, fabric-based systems have been developed which are much less costly than the metallic shutters or other devices, and which can provide a seal for the openings in the structure. In their simplest form, these systems include a sheet of fabric which is strong enough to withstand high winds and the forces of wind borne debris without rupturing. These fabric sheets may be attached to the structure on all four edges, thus providing protection for the structure against the wind even if the glass of a window, for example, has been broken.

In some such systems, a bar is attached to the fabric curtain at one end, and the other end of the curtain is attached to a roller stored in a housing or header much like a conventional window shade. The bar is utilized to lock the end of the curtain in a sill or the like when the curtain is in place protecting the opening in the building. Because the curtain may be subject to high stresses, the manner in which the curtain is attached to the roller and the bar could become important to the integrity of the system.

Moreover, the manner in which the edges of the fabric are maintained in the jambs or side rails which extend vertically between the header and the sill is important to the operation of the system. In some elaborate systems, the force of wind or debris impacting the curtain will lock or otherwise seal the fabric edges in the side rails. However, in other systems it is possible that such forces will merely displace the fabric out of its track in the side rails, and the need, therefore, exists for a system which will easily re-establish position of the edge of the fabric in the tracks of the side rails.

### DISCLOSURE OF THE INVENTION

It is thus an object of one aspect of the present invention to provide a storm curtain assembly which will automatically re-establish an edge of the fabric curtain which may have become displaced from a side rail.

It is an object of another aspect of the present invention to provide a unique manner in which to attach a bar to one end of the fabric curtain.

It is an object of an additional aspect of the present invention to provide unique manners in which to attach the other end of the fabric curtain to a storage roll.

These and other objects of the present invention, as well as the advantages thereof over existing prior art forms, which will become apparent from the description to follow, are accomplished by the improvements hereinafter described and claimed.

In general, a storm curtain assembly made in accordance with one aspect of the present invention includes a header and a side rail extending downwardly from each end of the header. A fabric curtain is provided on a roll positioned in the header. A track is formed in each side rail by spaced walls, and the fabric curtain is moveable along the side rails with the edges of the fabric curtain normally being received in the tracks. One of the walls of the tracks terminates at an upper edge spaced from the header so that if an edge of the fabric curtain is displaced from the track, the displaced edge will be allowed to be received in the track at the upper edge as the fabric curtain is being received on the roll.

In accordance with another aspect of the present invention, a storm curtain assembly includes a fabric curtain and a storage roll attached to one end of the fabric curtain. A bar having a plurality of sides is attached to the other end of the fabric curtain. The fabric curtain engages only two of the sides of the bar and is attached to one of the sides of the bar.

In another aspect of the present invention, a storm curtain assembly includes a fabric curtain and a storage roll. The storage roll has a circumferential notch therein which receives an end of the fabric curtain. That end is attached to the roll at the notch.

A storm curtain assembly also made according to the invention includes a header and a side rail extending downwardly from each end of the header. A roll having a circumferential notch therein is positioned in the header. One end of a fabric curtain is received in the notch and is attached to the roll at the notch. A bar having a plurality of sides is attached to the other end of the fabric curtain. The fabric curtain engages only two of the sides of the bar and is attached to one of the sides of the bar. A track is formed in each side rail by spaced walls. The fabric curtain is moveable along the side rails with the edges of the fabric curtain normally being received in the tracks. One of the walls of the tracks terminates at an upper edge spaced from the header so that if an edge of the fabric curtain is displaced from the track, the displaced edge will be allowed to be received in the track as the fabric curtain is being received on the roll.

A preferred exemplary storm curtain assembly according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a window having the protection of a storm curtain assembly in accordance with the present invention.

FIG. 2 is a somewhat schematic sectional view taken substantially along line 2-2 of FIG. 1.

FIG. 3A is a fragmentary perspective view having a portion of the housing cover broken away and showing the curtain in the process of being retracted with a portion of an edge of the fabric displaced from its track.

FIG. 3B is a view sequentially following FIG. 3A as the curtain is being retracted.

FIG. 3C is a view sequentially following FIG. 3B and showing the curtain fully retracted with the edge of the fabric having been reinserted into the track.

FIG. 4A is a somewhat schematic sectional view taken substantially along line 4-4 of FIG. 1 and showing the storage roll, curtain and lock bar in a position generally corresponding to that which is shown in FIG. 3A.

FIG. 4B is a view sequentially following FIG. 4A and showing the storage roll, curtain and lock bar in a position generally corresponding to that which is shown in FIG. 3B.

FIG. 4C is a view sequentially following FIG. 4B and showing the storage roll, curtain and lock bar when in the locked position with the curtain fully retracted, the position generally corresponding to that which is shown in FIG. 3C.

FIG. 5 is a somewhat schematic view showing the manner in which the fabric curtain may be attached to the lock bar.

FIG. 6A is a somewhat schematic view showing the manner in which the fabric curtain may be attached to the storage roll.

FIG. 6B is an alternative embodiment to that which is shown in FIG. 6A.

FIG. 6C is another embodiment to that which is shown in FIGS. 6A and 6B.

FIG. 6D is yet another embodiment to that which is shown in FIGS. 6A, 6B and 6C.

FIG. 6E is still another embodiment to that which is shown in FIGS. 6A, 6B, 6C and 6D.

### PREFERRED EMBODIMENTS FOR CARRYING OUT THE INVENTION

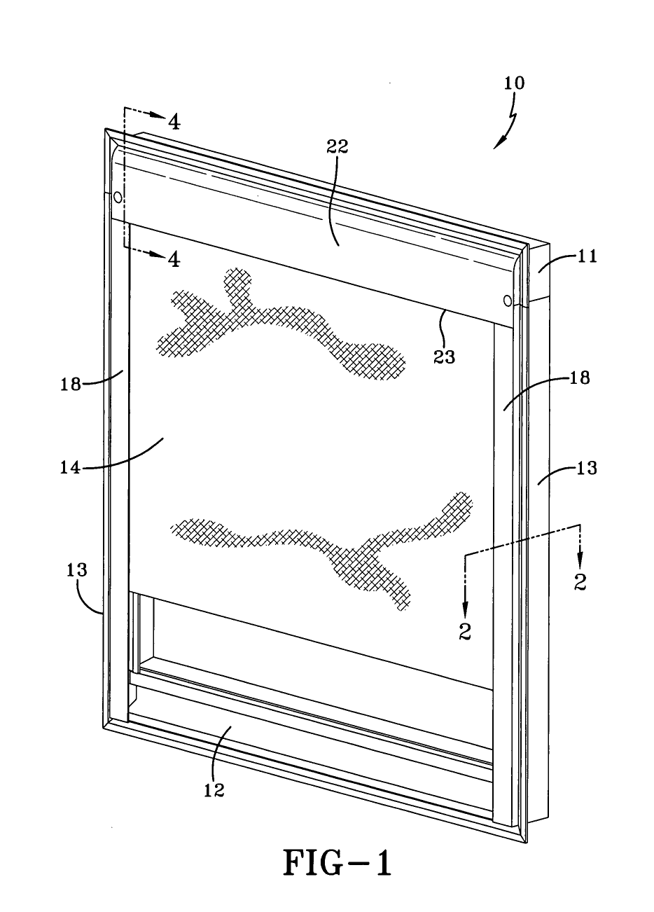

A storm curtain system, generally indicated by the numeral 10, is shown in FIG. 1 as covering an opening in a building. System 10 thus includes an upper header or housing 11, a lower sill 12, and opposed jambs or side rails 13 extending vertically from the ends of header 11 to the ends of sill 12. A fabric curtain 14 has one end attached to a storage roll 15 which is housed within header 11, and its other end carries a lock bar 16. Curtain 14 is made of a fabric material which can withstand the force of wind and airborne debris, as are often encountered in a hurricane or the like. Exemplary of such fabric is disclosed in U.S. patent application Ser. No. 11/190,114 filed on Jul. 25, 2005, to which reference is made for whatever details are necessary to understand the present invention.

Curtain 14 is stored on storage roll 15 when not in use and may be moved manually, or by a motor assembly (not shown) usually carried in header 11, from this stored position to an extended position to cover and protect an opening in a building. As such, curtain 14 moves along side rails 13 until lock bar 16 is received in bottom sill 12. At this point, a locking assembly (not shown) in bottom sill 12 and/or in the bottom of side rails 13, engages bar 16 to hold curtain 14 in place.

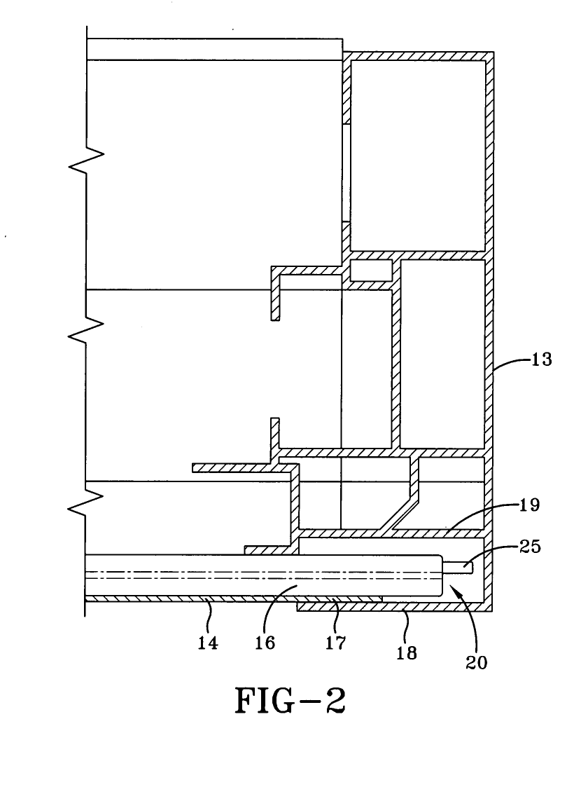

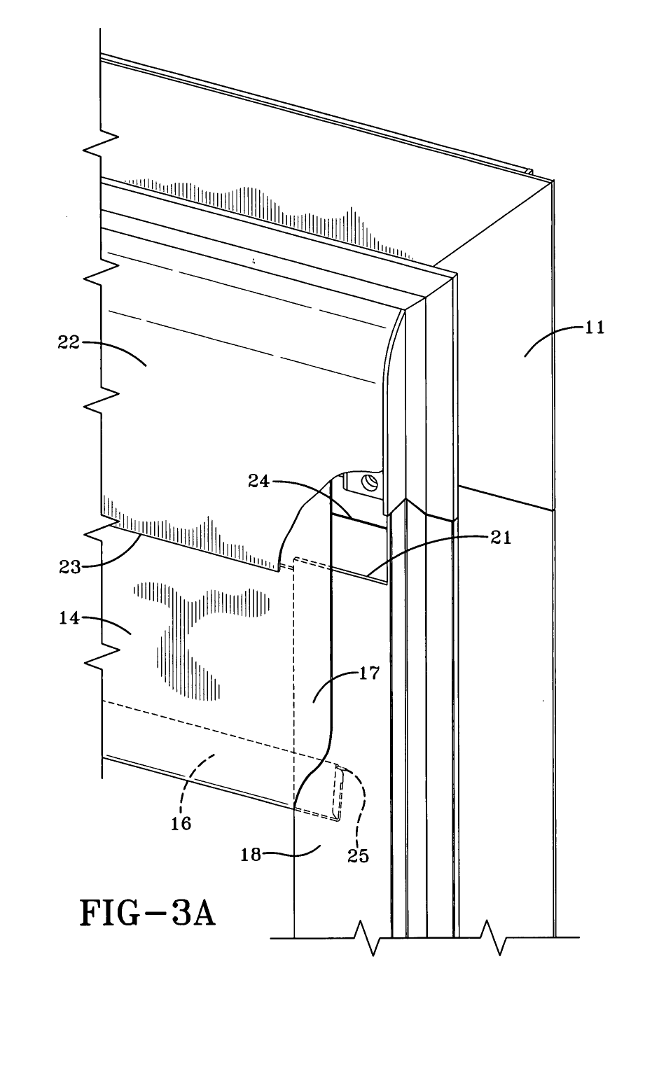

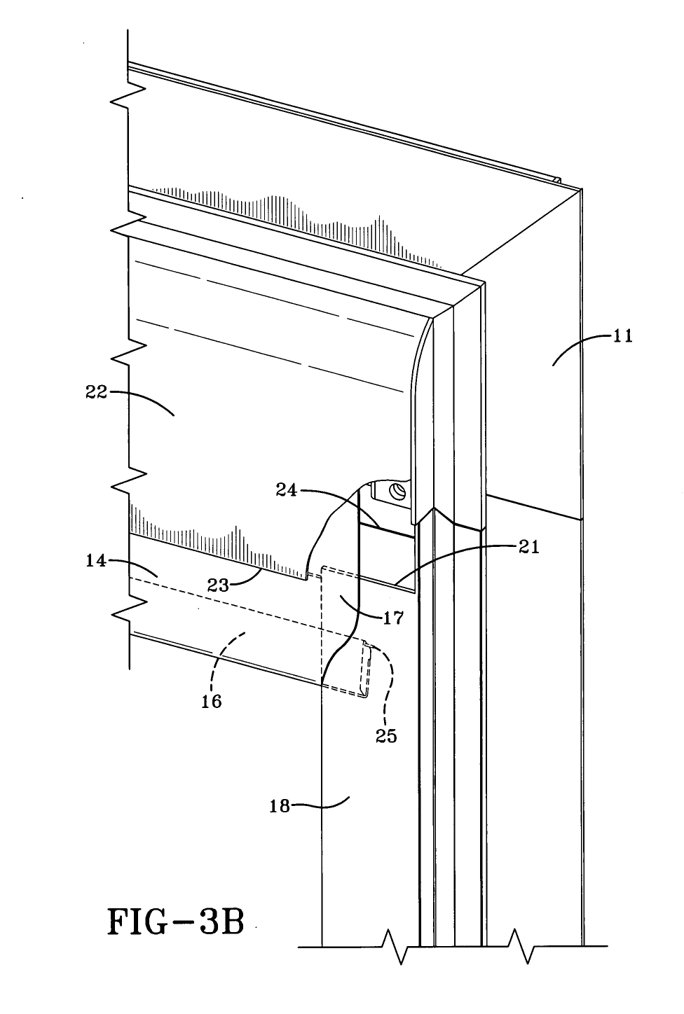

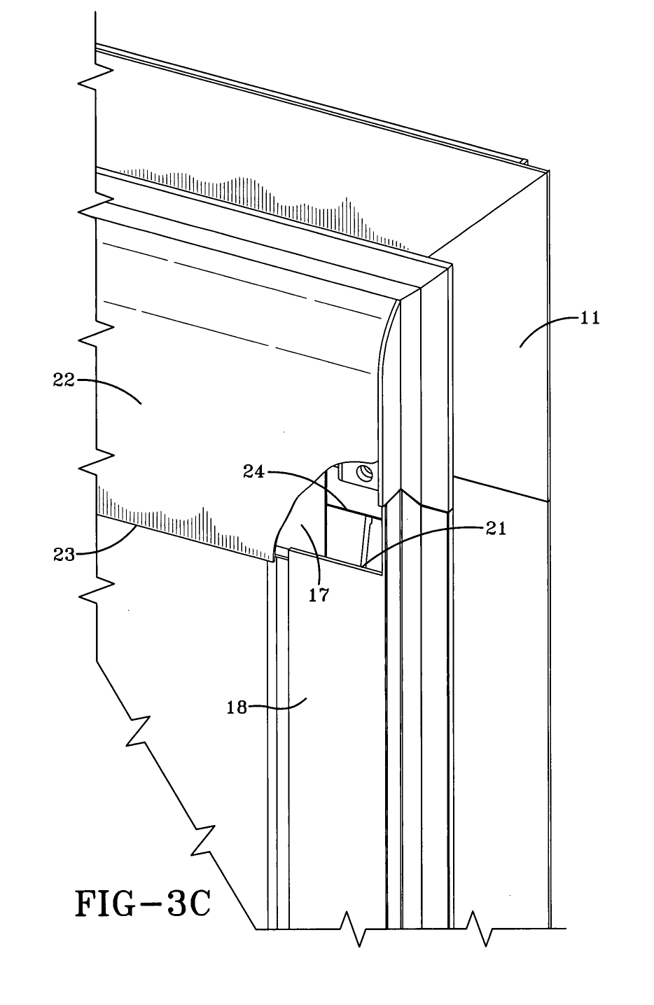

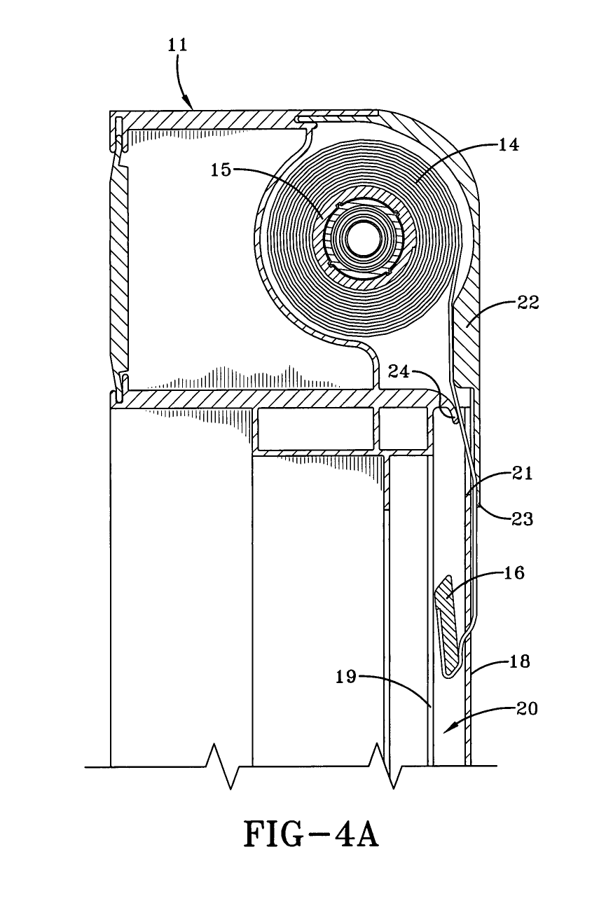

The manner in which the edge portions 17 of curtain 14 are received in side rails 13, in accordance with the present invention, is shown in FIG. 2. There, as shown, each side rail 13 includes a front plate 18 which, with a wall 19, defines a slot or track 20 within which the edge portions 17 of the fabric curtain 14 travel. Bar 16 further includes pins 25 which extends outwardly from the ends thereof. Pins 25 stabilize the horizontal position of bar 16 relative to side rails 13 within tracks 20. As best shown in FIGS. 3 (A, B, C) and 4 (A, B, C), plate 18 and thus track 20 terminates at an upper end 21 which is spaced from storage roll 15. Housing 11 includes a cover 22 which, as shown in FIGS. 4A, B and C, includes a lip 23 which is spaced from and overlaps the upper end 21 of plate 18.

In normal operation, the edge portions 17 of the curtain 14 will ride inside tracks 20 as the curtain 14 is being paid off the storage roll 15, and when the curtain 14 is being moved upwardly onto the storage roll 15. The edge portions 17 will exit tracks 20 as they pass the top end 21 of tracks 20 until lock bar 16 is engaged by a hook 24 formed in housing 11 as shown in FIG. 4C.

When the curtain 14 is fully down and covering the opening in a building, should the curtain 14 be exposed to an extreme force, such as impacts from wind borne debris, such that one or both of the edge portions 17 are displaced from their track 20, movement of the curtain 14 to wind it onto storage roll 15 will automatically direct the untracked edge portions 17 back into track 20 in a manner now to be described. FIGS. 3A and 4A show a condition where an edge portion 17 of the fabric is outside of track 20 with the edge of lock bar 16 still in the track area. As the curtain 14 is being moved upwardly onto the storage roll 15, from the FIGS. 3A, 4A position, through the FIGS. 3B, 4B position, and finally to the FIGS. 3C, 4C position, the edge portion 17 of the curtain 14 that is outside of the track 20 will pass in the space between the upper end 21 of plate 18 and the lip 23 of housing cover 22 until lock bar 16 is received in hook 24, as shown in FIG. 4C. It should be noted that when lock bar 16 is seated in hook 24, the lower extent of bar 16 is positioned in track 20 just below the upper end 21 of plate 18. Upon the subsequent lowering of curtain 14, its edge portions 17 will again be positioned in tracks 20. Thus, it should be evident that if one or both edge portions 17 of curtain 14 are displaced from tracks 20, all one has to do is to fully raise curtain 14 to draw edge portions 17 back into track 20.

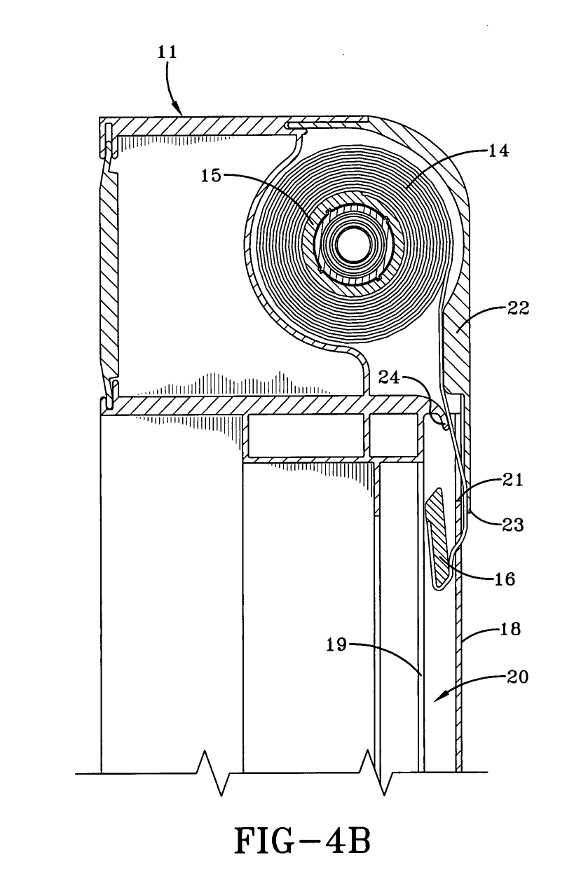

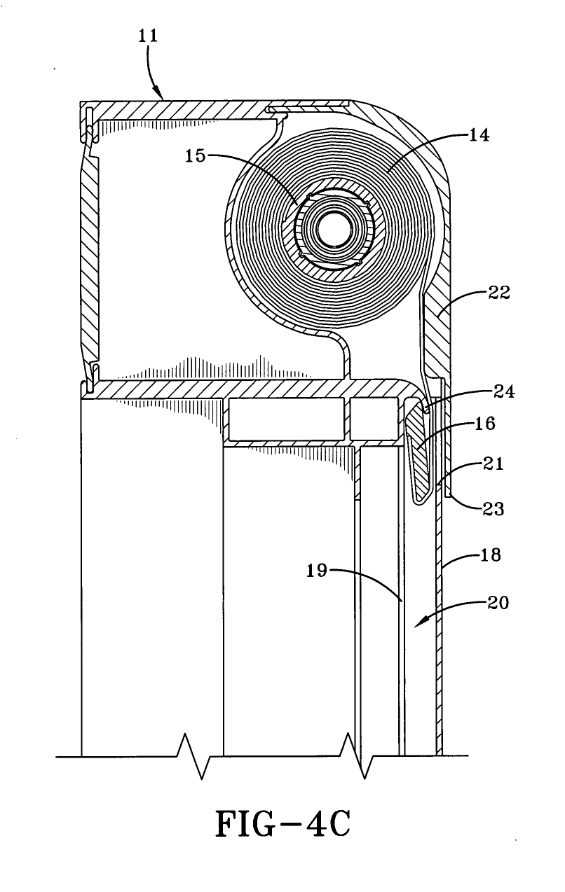

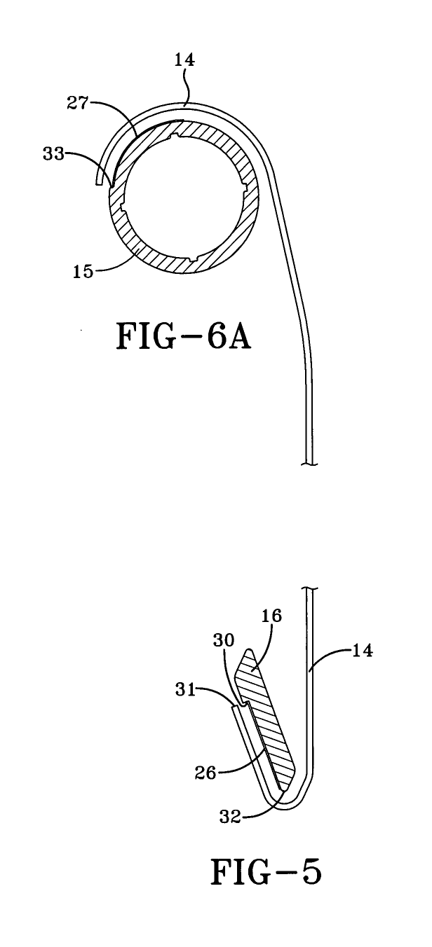

The manner in which curtain 14 is attached to lock bar 16 is best shown in FIG. 5. Bar 16 is generally shaped like a parallelogram and has one of its sides notched, as at 30. The depth of the notch 30 is preferably equal to the thickness of the fabric plus an adhesive 26 used to attach the fabric to the notched side. In this way, the end 31 of the fabric, which might be subject to fraying, is recessed and will not obstruct the travel of bar 16 in tracks 20 when the fabric is attached along the entire lateral width of bar 16 by a suitable adhesive. It should also be noted that when bar 16 reaches sill 12, to engage the locking assembly (not shown), it needs to pivot at point 32. To assure that such pivoting freely occurs, the fabric of curtain 14 is relatively flexible and is wrapped around the bottom of bar 16 to form generally the J-shaped configuration shown in FIG. 5. Thus, fabric curtain 14 is not only attached only to one side of the bar 16, but also it engages only two adjacent sides of the bar 16. It should be appreciated that the tip 32 of bar 16 cannot be too acute an angle, as undue stress may be placed on curtain 11. Further, an overly acute angle may prevent proper biasing. Likewise, a tip 32 which is overly rounded is undesirable because a crease will not form in curtain 11. It has been found that the development of a crease at tip 32 may promote proper pivoting.

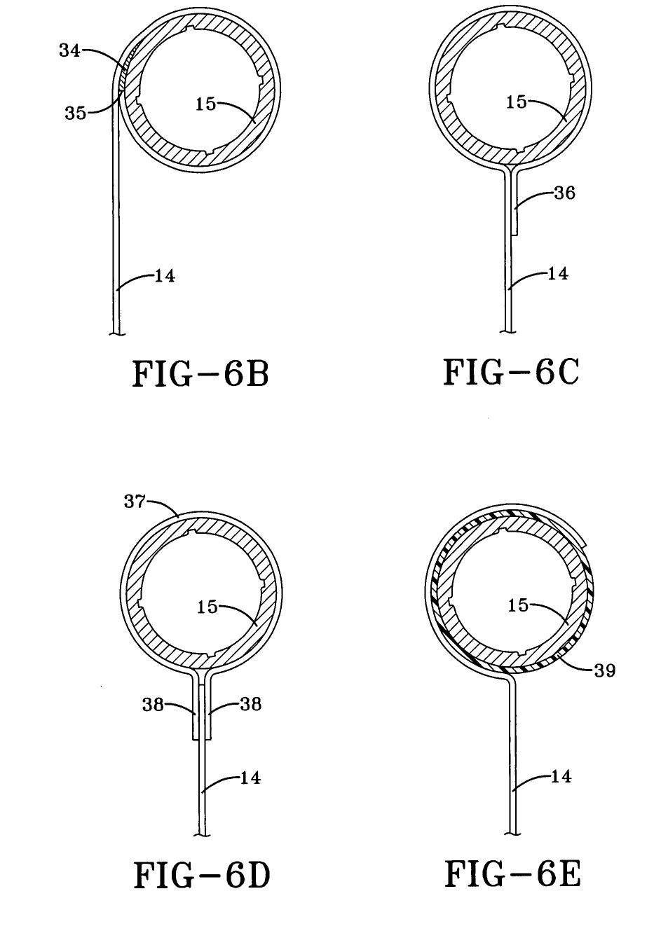

One manner in which the curtain 14 is attached to storage roll 15 is shown in FIG. 6A. There, it is shown that storage roll 15 is circumferentially notched, as at 33, to a depth approximating the thickness of the fabric of curtain 14 and an adhesive 27 that is used to attach the fabric to storage roll 15. In one embodiment, adhesive 27 is disposed over substantially the entire lateral width of storage roll 15 and over approximately 90 degrees of the circumference. As such, as storage roll 15 turns, a helix spiral is developed such that curtain 14 will wrap around storage roll 15 in a natural spiral as the curtain 14 is being stored on roll 15. Were the storage roll 15 not notched, the thickness of the curtain 14 on the storage roll 15 would vary.

A variation of the attachment system of FIG. 6A is shown in FIG. 6B. There, a wedge 34 having opposed arcuate surfaces can be attached to the periphery of storage roll 15 which, in effect, creates a notch 35 like notch 33. The height of notch 35 is also designed to correspond to the thickness of the fabric of curtain 14 and the necessary adhesive, and it can thus be wound on storage roll 15 in the same manner with the same result as the embodiment of FIG. 6A.

Another fabric-to-roll attachment system is shown in FIG. 6C. There, the end of the fabric of curtain 14 is looped around storage roll 15 and itself as at 36. This attachment can be stitching, adhesive, welding or by any suitable means known in the art. The looped portion of the fabric may be attached to the storage roll 15 by any suitable adhesive. In another embodiment, the looped portion may include a diameter which is the same or slightly smaller than the storage roll 15, and the storage roll 15 may include a plurality of bores (not shown). A pressurized gas, such as air, may be applied to the interior of storage roll 15 as the looped portion of curtain 14 is drawn over the storage roll 15. In such a case, the gas transmitted through the bores would allow the curtain 14 to be slipped over the storage roll 15. Thereafter, the pressure may be removed and the curtain 14 would thereafter be secured to the storage roll 15 through frictional contact. In a similar fashion shown in FIG. 6D, a separate fabric connector 37 can be looped around and attached to roll 15. Then the tab ends 38 of connector 37 can sandwich the end of the fabric of curtain 14, and the three layers can be attached as by stitching adhesive, welding or the like.

At times it may be difficult to adhere the fabric of curtain 14 to the storage roll 15 which is usually made of an aluminum material. If such occurs, as shown in FIG. 6E, it is contemplated that a polyvinylchloride tube 39 may be first adhered to roll 15 and then the fabric of curtain 14 may be attached to tube 39 by conventional means.

In view of the foregoing, it should be evident that a curtain attached to the roll and lock bar as described herein, and operable so that the edges thereof can be automatically repositioned in the tracks of the side rails should they become removed therefrom, substantially improves the fabric storm curtain art.

What is claimed is:

1. A storm curtain assembly comprising a header, a side rail extending downwardly from each end of said header, a fabric curtain provided on a roll in said header, and a track formed in each side rail by spaced walls, said fabric curtain being moveable along said side rails with the edges of said fabric curtain normally being received in said tracks, one of said walls of said tracks terminating at an upper edge spaced from said header so that if an edge of said fabric curtain is displaced from said track, the displaced edge will be allowed to be received in said track at said upper edge as said fabric curtain is being received on said roll.

2. The assembly of claim 1 wherein said header includes a cover having a lip which overlaps said upper edge and is spaced from said upper edge, a displaced edge of said fabric curtain being moveable in the space between said lip and said upper edge.

3. The assembly of claim 1 further comprising a bar attached to the end of said fabric curtain opposite said roll.

4. The assembly of claim 3 wherein said header includes a hook to engage said bar when said fabric curtain is at the end of its upward travel.

5. The assembly of claim 3 wherein said bar is generally parallelogram-shaped and said fabric curtain engages only two of the sides of said bar.

6. The assembly of claim 3 further comprising means for attaching said fabric curtain to said bar.

7. The assembly of claim 6 wherein said means includes a notch formed in one side of said bar, and an adhesive and the end of said fabric curtain being received in said notch.

8. The assembly of claim 7 wherein the depth of said notch is generally equal to the thickness of said fabric curtain and the thickness of said adhesive.

9. The assembly of claim 1 further comprising means for attaching said fabric curtain to said roll.

10. The assembly of claim 9 wherein said means includes a notch formed on said roll, and an adhesive and the end of said fabric curtain being received in said notch.

11. The assembly of claim 10 wherein the depth of said notch is generally equal to the thickness of said fabric curtain and the thickness of said adhesive.

12. The assembly of claim 9 wherein said means includes a wedge attached to said roll, said wedge forming a notch to receive the end of said fabric curtain.

13. The assembly of claim 9 wherein said means includes a loop formed on the end of said fabric curtain, said loop being positioned around said roll.

14. The assembly of claim 9 wherein said means includes a fabric connector carried by said roll, said fabric connector having tab ends to engage the end of said fabric curtain.

15. The assembly of claim 9 wherein said means includes a tube attached to said roll, said fabric curtain being attached to said tube.

16. A storm curtain assembly comprising a fabric curtain, a storage roll attached to one end of said fabric curtain, a bar attached to the other end of said curtain, said bar having a plurality of sides, said fabric curtain engaging only two of said sides and being attached to one of said sides.

17. The storm curtain assembly of claim 16 wherein a notch is formed on one of said sides of said bar, one end of said fabric curtain being received in said notch and attached to said bar at said notch.

18. A storm curtain assembly comprising a fabric curtain and a storage roll, said storage roll having a circumferential notch therein, one end of said fabric curtain being received in said notch and attached to said roll at said notch.

19. A storm curtain assembly comprising a header, a side rail extending downwardly from each end of said header, a roll in said header, said roll having a circumferential notch therein, a fabric curtain, one end of said fabric curtain being received in said notch and attached to said roll at said notch, a bar attached to the other end of said fabric curtain, said bar having a plurality of sides, said fabric curtain engaging only two of said sides and being attached to one of said sides, a track formed in each side rail by spaced walls, said fabric curtain being moveable along said side rails with the edges of said fabric curtain normally being received in said tracks, one of said walls of said tracks terminating at an upper edge spaced from said header so that if an edge of the said fabric curtain is displaced from said track, the displaced edge will be allowed to be received in said track as said fabric curtain is being received on said roll.
